(19) United States
(12) Patent Application Publication
(10) Pub. No.: US 2010/0011157 A1
(43) Pub. Date: Jan. 14, 2010

(54) DEVICE AND METHOD FOR BACKING UP DATA ON NON- VOLATILE MEMORY MEDIA, OF THE NAND FLASH TYPE, DESIGNED FOR ONBOARD COMPUTERS

(75) Inventors: Matthieu Baig, Issy-Les-Moulineaux (FR); Nicolas Charrier, Limours (FR); Sebastien Tricot, Massy (FR)

Correspondence Address: DARBY & DARBY P.C., P.O. BOX 770, Church Street Station, New York, NY, 10008-0770, US

(73) Assignee: Thales, Neuilly Sur Seine (FR)

(21) Appl. No.: 12/491,942

(22) Filed: Jun. 25, 2009

(30) Foreign Application Priority Data
Jul. 8, 2008 (FR) 08 03879

(51) Int. Cl. G06F 12/02

(52) U.S. Cl. 711/103; 711/E12.008

(57) ABSTRACT

The present invention relates to a device making it possible to manage a flash memory component designed for onboard computers notably in the aviation field. In particular, the invention makes it possible to use NAND flash memory media in fields such as aviation, by virtue of its judicious organisation and management of the flash memory components. On the one hand it makes it possible to optimise and on the other hand to control the lifetime of the flash memories.

### CROSS-REFERENCE TO RELATED APPLICATION

The present application claims the benefit of French Patent Application No. 08 03879, filed on Jul. 8, 2008, which is hereby incorporated by reference in its entirety.

### FIELD OF THE INVENTION

The present invention relates to a device making it possible to manage a flash memory component designed for onboard computers. More precisely, the invention proposes a device and a method for protecting the integrity of data backed-up on flash memory media, and to optimise the longevity of these media. In particular, the invention makes it possible to use NAND flash memory media in fields such as aviation, for which the integrity of the backed-up data and the lifetime of the components are of crucial importance.

### BACKGROUND OF THE INVENTION

Currently, in the aviation field, the flight management systems require ever greater computer data backup and storage capacities. These needs in terms of storage capacity have thus been multiplied a thousand-fold, even a million-fold, rising from a few kilobytes a few years ago to at least one gigabyte today. The data to be backed-up may also be increasingly detailed geographic or air maps, flight plans or critical data such as the altitude or speed of the aircraft. Currently, the non-volatile memories that may be used in aviation are of the NOR flash type. NOR flash memories have an addressing system allowing rapid and random access to any one of their available sectors. Their main advantage is that they guarantee 100% integrity of the backed-up data. On the other hand they exhibit performance that is not compatible with the current needs in the matter of storage capacity or writing bit rate. These NOR flash memories are currently in competition with memories of the NAND flash type. NAND flash memories have the advantage of being able to achieve high storage capacities at much lower costs than NOR flash memories. An example of optimised management of NAND flash memories is given in the prior art by the document entitled “Design of a reliable NAND Flash Software for Mobile Device”, Computer and Information Technology, 2006 IEEE, TAEHOON KIM ET AL. The main defect with NAND flash memories lies in the fact that the integrity of the stored data is not guaranteed. It is essentially for this reason that NAND flash memories are not used in the aviation field, in particular for backing up critical data. Another disadvantage of NAND flash memories arises from the fact that their interface allows only one sequential access to the data. Consequently it is difficult to guarantee the lifetime of this type of memory, the manufacturers of NAND flash memories guaranteeing only a maximum number of erasure cycles supported by the various memory sectors. However, NAND flash memories also have a performance that is very attractive and markedly superior to that of NOR flash memories in the matter of access times, the number of erasure cycles supported, the storage capacity and write bit rate. Their already massive use for “consumer” applications today seems necessary in the aviation field.

An object of the invention is therefore to increase the reliability of NAND flash memories and to ensure that they are future-proof.

Currently, the main technique designed to enhance the future-proofing of NAND flash memories consists in applying the principle of “wear levelling” of the various memory sectors. Specifically, a flash memory consists of sectors; for example, a gigabyte flash memory comprises 8192 sectors of 128 kilobytes each. When a modification has to be made in a sector, the latter is totally erased and then re-written. This therefore involves making the aging of the memory sectors more uniform, that is to say ensuring that the user systematically writes in the available sector that has undergone the least erasure cycles. In this manner, all the memory sectors age at the same rate, which makes it possible to optimise the lifetime of the NAND flash memory.

With respect to the integrity of the backed-up data, error correcting codes have currently been perfected. Their main defect lies in the fact that they consume large amounts of memory space and computing times.

In this context, the invention proposes a device and a method making it possible to apply the principle of levelling the wear of the sectors of flash memory components and other innovative principles for the purpose of protecting back-up to NAND flash memory.

### SUMMARY OF THE INVENTION

Accordingly, the subject of the invention is a device for backing up data on a non-volatile memory medium designed for onboard computers, notably in the aviation field, said device comprising:
a microcontroller having a random access memory,
a flash memory component,

said flash memory component comprising N sectors dedicated to the backup of files and messages, said files pointing to said messages, said backup-dedicated sectors having an address and comprising corrupted backup-dedicated sectors and uncorrupted backup-dedicated sectors, said uncorrupted backup-dedicated sectors exhibiting a number of erasure cycles undergone, wherein the flash memory component also comprises a master table block comprising:
a corrupted sectors table, for listing the addresses of the corrupted backup-dedicated sectors,
a wear levelling table, for listing the number of erasure cycles undergone associated with each of the uncorrupted backup-dedicated sectors,
a logbooks and messages table, comprising a set of file identifiers, each file containing messages which are associated with it, said message table making it possible to list the addresses of the backup-dedicated sectors containing the data associated with said messages;

and said backup device also comprises:
means for erasing and recreating said master table block at a different address on each modification of at least one backup-dedicated sector.

Advantageously, said flash memory component having a nominal lifetime, corresponding to the envisaged lifetime of said flash memory component, the flash memory component has an erasure frequency corresponding to the average time between two backup-dedicated sector erasure cycles, computed over all the uncorrupted backup-dedicated sectors, said erasure frequency having to be less than a maximum erasure frequency for the purpose of ensuring the nominal lifetime of said flash memory component.

In one exemplary embodiment of the invention, said flash memory component having a nominal lifetime of between 20 years and 30 years, and having approximately 8000 to 10000 sectors dedicated to the memory, each backup-dedicated sector having a guaranteed operation of up to approximately 100000 erasure cycles, the maximum erasure frequency is of the order of 1 per second.

Advantageously, the sum of the periods during which the flash memory component is powered up, called the duration of use of the flash memory, is saved in the master table block, making it possible to determine said erasure frequency of the flash memory component.

Advantageously, said erasure frequency may, for short periods, exceed the maximum erasure frequency.

Advantageously, said flash memory component may be of the NAND flash type.

In one exemplary embodiment of the invention, said master table block has a reserved memory space corresponding to a backup-dedicated sector, said corrupted sectors table has a reserved memory space that is less than or equal to approximately 1% of the memory space reserved for said master table block, said wear levelling table has a reserved memory space of between 20% and 30% of the memory space reserved for said master table block, said logbooks and messages table has a reserved memory space of between 30% and 40% of the memory space reserved for said master table block.

Advantageously, a management method for a device for backing up data on a non-volatile memory medium according to the invention comprises the following steps:
when said flash memory component starts up:
   reading of all the backup-dedicated sectors and locating of the master table block, called old master table block,
   loading, into the random access memory of the microcontroller, of said old master table block comprising the corrupted sectors table, the wear levelling table and the logbooks and messages table,
when a message is written on the flash memory component:
   erasure of the sector dedicated to the available memory having the smallest number of erasure cycles undergone, called the youngest sector,
   writing of said message in said youngest sector,
   writing of a new master table block, by applying the two steps of erasure followed by writing described above,
   erasure of the old master table block.

Advantageously, the reading of all the backup-dedicated sectors for the purpose of locating the master table block in line with the method according to the invention culminating initially in the location of several possible master table blocks, said master table block has an identifier associated with its date of last modification, making it possible to identify the correct master table block, that is the most recent.

Advantageously, said device having approximately 10 milliseconds before ceasing to operate in the event of an electricity supply disconnection, said 10 milliseconds allow the saving of the master table block, said master table block comprising information tracing the interruption of a possible operation in progress.

Advantageously, the management of said flash memory component is provided by a software program that is present on said microcontroller.

### BRIEF DESCRIPTION OF THE DRAWINGS

Other features and advantages of the invention will appear with the aid of the following description made with respect to the appended drawings which represent:

FIG. 1: the schematic diagram of the management of a flash memory by a microcontroller;

FIG. 2: the schematic diagram of the organisation into files and messages of the data on a flash memory;

FIG. 3: the schematic diagram representing the content of a master table block in the device according to the invention;

FIG. 4: the schematic diagram describing the method for managing NAND flash memory according to the invention.

### DETAILED DESCRIPTION OF THE INVENTION

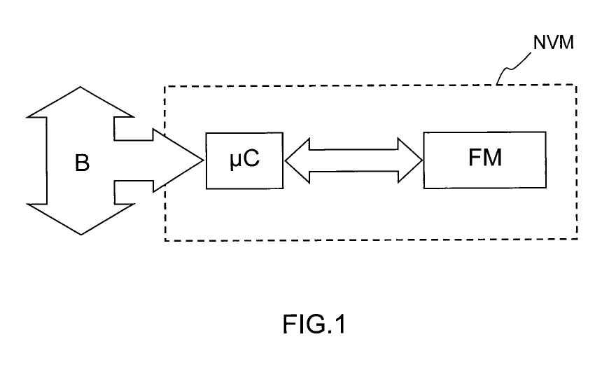

FIG. 1 shows a simple diagram making it possible to describe the principle of managing a flash memory FM component in a device according to the invention. The device according to the invention, NVM, performs a memory function by means of the assembly consisting of the storage matrix of the flash memory FM itself and of the microcontroller μC. The storage matrix of the flash memory FM consists of a set of sectors, called erasure sectors. It is not possible to partially modify a sector: to modify the data contained in a sector, it is necessary to erase said sector and then etch the updated data. It is this erasure operation which contributes to the ageing of the sector, and hence of the flash memory FM.

The device described in this instance is integrated into an environment comprising an aviation computer. Data routed via the bus B are written in the flash memory FM or read onto said flash memory FM. The reading and writing in the flash memory FM is managed by a software layer present on the microcontroller μC. This layer of hardware abstraction makes it possible to manage the reads and writes and the erasures of sectors of the flash memory FM. For this, management of the flash memory FM does not rely on direct addressing of the various sectors of the flash memory FM, but on the logical identifiers of files and messages.

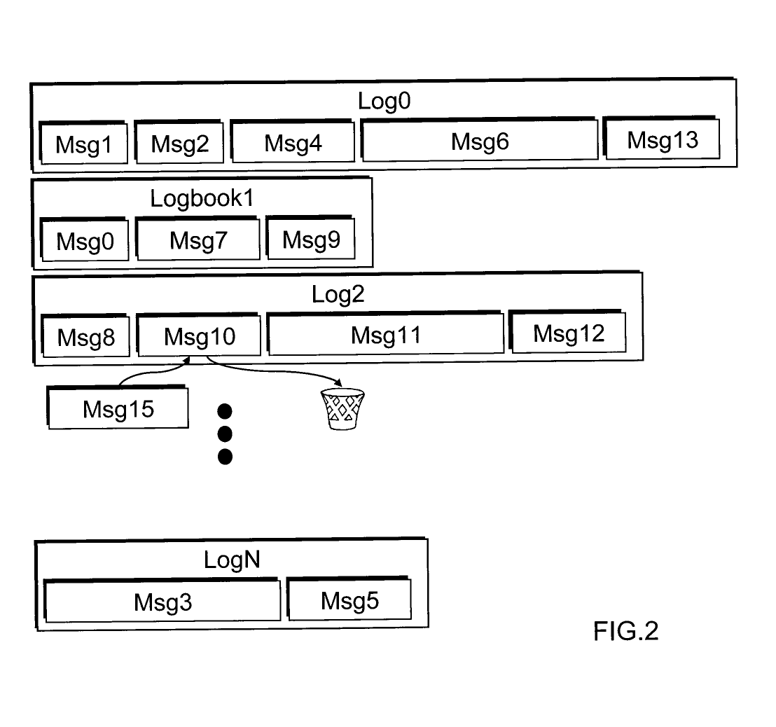

On this matter, FIG. 2 illustrates the organisation into files and messages of the data written in the flash memory FM of a device according to the invention. The data etched in the flash memory FM is therefore organised into files Log0, Log1, Log2, LogN which each contain a set of messages, respectively Msg1-Msg2-Msg4-Msg6-Msg13, Msg0-Msg7-Msg9, Msg8-Msg10-Msg11-Msg12, Msg3-Msg5. It is possible to modify a message inside a file, for example the message Msg10 may be replaced by the message Msg15 in the file Log2. To carry out this operation, the message Msg10 is first deleted and then the message Msg15 is etched into the file Log2.

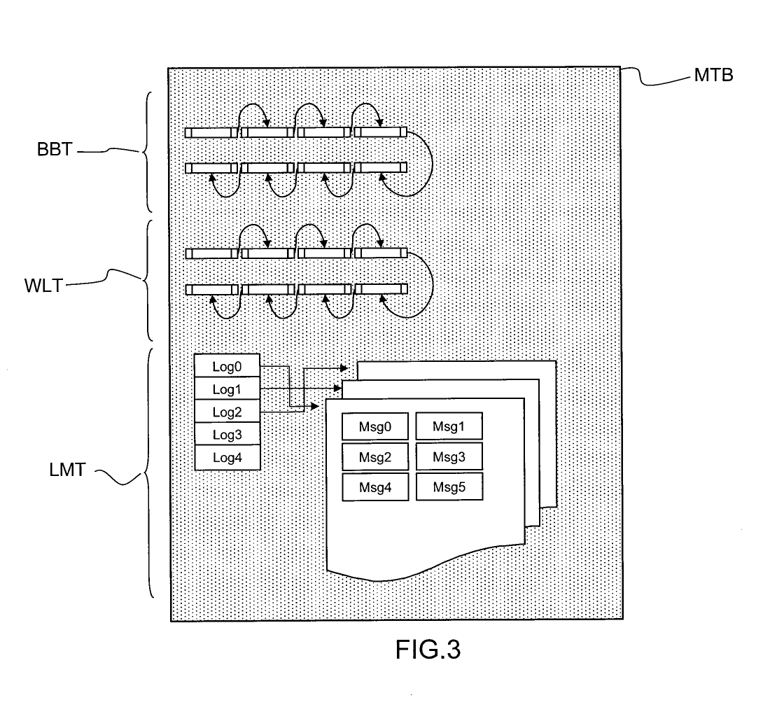

FIG. 3 represents the diagram of the organisation of the flash memory FM in a device according to the invention. This point is a key element of the invention. The organisation of the flash memory FM is based on the creation and the management of a master table block MTB. This master table block MTB, which may also be called a start-up block, contains the data allowing the management of the flash memory FM to be optimised. It is etched in a sector of said flash memory FM. One of the basic elements of the invention consists in using the principle already mentioned of “wear levelling” of the various sectors of the flash memory FM. Accordingly, the master table block MTB comprises a “corrupted sectors table” BBT making it possible to list the addresses of all the corrupted sectors of the flash memory FM. In these sectors, no data can be understood to be backed-up.

The master table block MTB furthermore comprises a “wear levelling table” WLT. This table WLT lists, for each valid sector, the number of erasures that it has undergone. This number of erasures undergone corresponds to the level of wear, or to the age, of said sector. Finally, the master table block comprises a “logbooks and messages table” LMT listing the logical addresses of the files contained in the flash memory FM. These files point to messages according to the description of FIG. 2.

On each write or erase access of the flash memory FM, the master table block MTB is modified. Being backed-up in a sector of the flash memory FM, itself subjected to ageing due to the erasures, the master table block must be backed-up to a different address each time it is modified.

Starting with the operation of the master table block described above, the management of the flash memory FM is performed with the following steps:
on start-up of the device, the microcontroller μC, which is shown in FIG. 1 and which has a random access memory, scans the whole of the flash memory FM, identifies the master table block MTB and loads it into its random access memory;
when data are written into the flash memory FM, the microcontroller consults the master table block MTB: reading the corrupted sectors table BBT and wear levelling table WLT and allocation LMT makes it possible to determine the sector that is uncorrupted and available that has undergone the least erasures. It is in this sector that the data are etched.

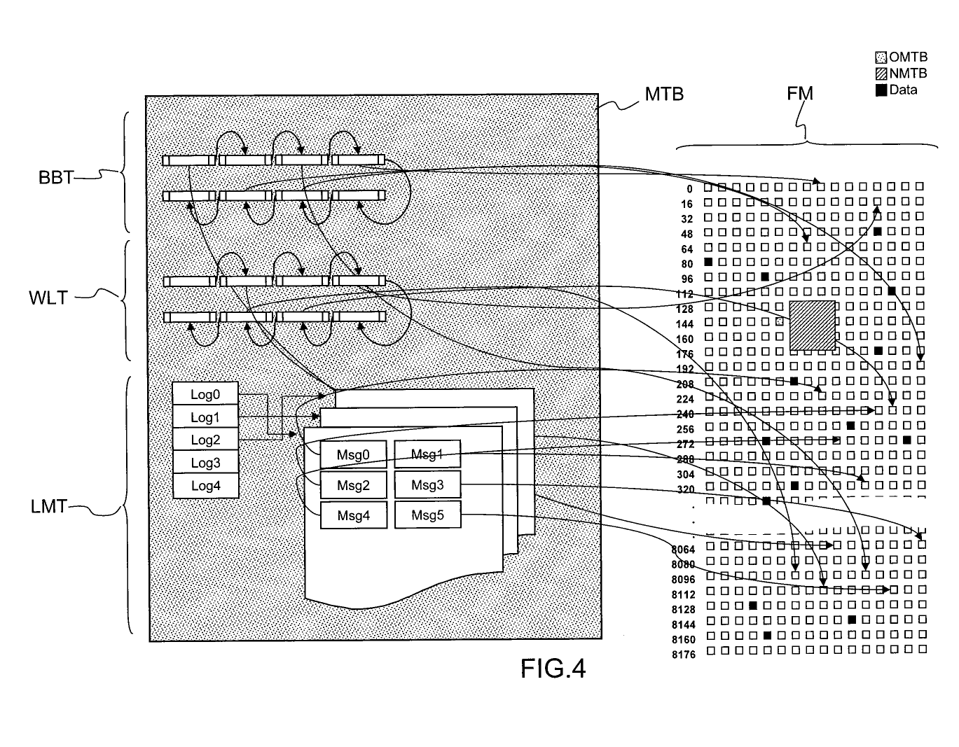

The diagram of FIG. 4 will make it possible to explain in detail the flash memory FM management process introduced above. It is possible to specify first of all that the corrupted sectors table BBT is a sequenced list of variable length comprising the addresses of the corrupted sectors which must no longer be used. The maximum size of this table BBT corresponds, in bits, to the total number of sectors in the memory, the uncorrupted or corrupted state of a sector being able to be coded on one bit. Then, the wear levelling table WLT comprises, for each sector, the number of erasures undergone. This is a sequenced list of invariable length. Finally, the logbooks and messages table LMT takes the form of a list of identifiers of files Logo, Log1, Log2, Log3, Log4, with associated information, such as the number of messages and the list of the addresses of the messages that each file contains. For example, the file Log0 in this instance contains the messages Msg0, Msg1, Msg2, Msg3, Msg4 and Msg5. Each message is associated with a certain number of characteristics, such as its size, and the list of physical sectors that it occupies. Beginning with the description of FIG. 3, it is possible to explain the management of the flash memory FM in the device according to the invention. The master table block detected on start-up is loaded into the random access memory of the microcontroller μC; it is possible to qualify the master table block as an old master table block OMTB. Data, for example the file Log0 comprising the messages Msg0, Msg1, Msg2, Msg3, Msg4 and Msg5 are written into the available sectors that have undergone the least erasures. Then, the master table block is updated and the new master table block NMTB is etched onto the flash memory FM at a different address from that of the old master table block OMTB.

Moreover, it is possible to note that there is a risk of detecting several master table blocks on start-up of the device, for example because the old block was not erased after the writing of the new, or because a power cut occurred before the old master table block was erased. The master table block is therefore advantageously furnished with an identification pattern. This pattern, linked for example to the date on which said block was last modified, makes it possible to determine the correct master table block.

Finally, in addition to making it possible to optimise the longevity of the flash memory FM of the device, the invention also makes it possible to control the said longevity. To do this, it is possible to save the period of use of the flash memory FM, corresponding to the sum of the periods during which the flash memory is powered up. This data may be stored in the master table block MTB. This value makes it possible to compute an erasure frequency of the flash memory FM sectors, corresponding to the average time passing between two erasures of a sector, this average being computed over all the sectors.

Therefore, it is possible to determine a maximum erasure frequency not to be exceeded without risking that the flash memory FM does not achieve the expected longevity.

Take for example the case of a device comprising a flash memory FM with a capacity of one gigabyte, consisting of 8192 sectors of 128 kilobytes each. Considering that the manufacturer of the flash memory guarantees the operation of the sectors up to 100000 erasure cycles, then, if it desired that the longevity of the device and of the flash memory in particular corresponds to that of the aviation computer into which it is incorporated, that is conventionally 25 years, the maximum erasure frequency is:

$$\frac{25 \times 365 \times 24 \times 60 \times 60}{8192 \times 100000} \approx 1$$

erasure per second. If this average value is exceeded, it is very likely that the flash memory will have a lifetime of less than the desired 25 years. It should nevertheless be noted that the device may perfectly tolerate occasionally exceeding the maximum erasure frequency when data are written in bursts in the flash memory FM. This causes a state of overload of the flash memory FM for a short time, but the erasure frequency may subsequently be reduced, in order to revert to nominal conditions of use.

With respect to the size of the master table block MTB, based on the exemplary application described above and on the first paragraph of the description of FIG. 4, the following values are obtained: the corrupted sectors table BBT requires 8192 bits, or 1024 bytes; the wear levelling table WLT requires a reserved space of 32768 bytes, or, for each sector, 4 bytes comprising 17 bits making it possible to code the number of erasure cycles undergone and 13 bits making it possible to code the address of said sector. The size of the logbooks and messages table LMT is in principle variable. It is in fact limited by the size of a sector, the master table block MTB having to require only one sector. It is possible to reserve 40960 bytes for the logbooks and messages table LMT. The bytes still available in the sector of the master table block MTB may be used to store the pattern identifying said master table block MTB and the period of use of the memory or else the erasure frequency.

In summary, the invention has two major advantages: by virtue of its judicious organisation and management of flash memory components, it makes it possible on the one hand to optimise and on the other hand to control the lifetime of said flash memory components.

It also makes it possible to protect the data back-up on this type of non-volatile memory, in particular in flash memories of the NAND flash type, making it possible for them to be used in the context of aviation computers.

1. Device for backing up data on a non-volatile memory medium of onboard computers, the device comprising:
a microcontroller having a random access memory; and
a flash memory component, wherein the flash memory component comprises:
N backup-dedicated sectors used to backup files and messages, the files associated with one or more of the messages, the backup-dedicated sectors having one or more respective addresses and comprising:
corrupted backup-dedicated sectors; and
uncorrupted backup-dedicated sectors,
wherein the uncorrupted backup-dedicated sectors exhibit a number of completed erasure cycles;
the flash memory component further comprises a master table block comprising:
a corrupted sectors table, to list the addresses of the corrupted backup-dedicated sectors;
a wear levelling table, to list the number of completed erasure cycles associated with each of the uncorrupted backup-dedicated sectors; and
a logbook and message table, comprising a set of file identifiers to identify one or more files, each file containing one or more messages, the logbook and message table making it possible to list the addresses of the backup-dedicated sectors containing the data associated with the messages; and
the backup device further comprises:
a circuit to erase and to recreate the master table block at a different address upon each modification of at least one backup-dedicated sector.

2. Device according to claim 1, wherein the flash memory component has a nominal lifetime, that corresponds to the envisaged lifetime of the flash memory component, wherein the flash memory component has an erasure frequency that corresponds to the average time between two backup-dedicated sector erasure cycles, computed over all the uncorrupted backup-dedicated sectors, the erasure frequency being less than a maximum erasure frequency in order to ensure the nominal lifetime of the flash memory component.

3. Device according to claim 2, wherein the flash memory component has a nominal lifetime of between 20 years and 30 years, further comprising approximately 8000 to 10000 backup-dedicated sectors, each backup-dedicated sector having a guaranteed operation of up to approximately 100000 erasure cycles, wherein the maximum erasure frequency is of the order of 1 per second.

4. Device according to claim 2, wherein a duration of use of the flash memory, corresponding to a sum of the periods during which the flash memory component is powered up, is saved in the master table block, making it possible to determine the erasure frequency of the flash memory component.

5. Device according to claim 2, wherein for predetermined short periods the erasure frequency exceeds the maximum erasure frequency.

6. Device according to claim 1, wherein the flash memory component is of the NAND flash type.

7. Device according to claim 1, wherein:
the master table block comprises a reserved memory space that corresponds to a backup-dedicated sector;
the corrupted sectors table comprises a reserved memory space that is less than or equal to approximately 1% of the memory space reserved for the master table block;
the wear levelling table comprises a reserved memory space of between about 20% and about 30% of the memory space reserved for the master table block; and
the logbook and message table comprises a reserved memory space of between about 30% and about 40% of the memory space reserved for the master table block.

8. Management method for a device for backing up data on a non-volatile memory medium according claim 1, comprising the steps of:
when the flash memory component starts up:
reading all the backup-dedicated sectors;
locating the master table block, designated an old master table block; and
loading, into the random access memory for the microcontroller, the old master table block comprising the corrupted sectors table, the wear levelling table and the logbook and message table;
when a message is written on the flash memory component:
erasing the youngest sector, the youngest sector corresponding to the sector dedicated to the available memory having the smallest number of completed erasure cycles;
writing the message in the youngest sector;
writing a new, up-to-date master table block, by:
erasing the youngest sector and writing the message; and
erasing the old master table block.

9. Method according to claim 8, wherein the reading of all the backup-dedicated sectors for the purpose of locating the master table block culminates initially in the location of several possible master table blocks, wherein the master table block has an identifier associated with its date of last modification, making it possible to identify the correct master table block, that is the most recent.

10. Method according to claim 8, wherein the device has approximately a 10 millisecond time period before ceasing to operate in the event of an electricity supply disconnection, wherein the 10 millisecond time period allows the saving of the master table block, wherein the master table block comprises information to trace the interruption of a possible operation in progress.

11. Method according to claim 8, wherein the management of the flash memory component is provided by a software program that is executed by the microcontroller.

12. Device according to claim 4, wherein the erasure frequency may, for predetermined short periods, exceed the maximum erasure frequency.

13. Device according to claim 4, wherein the flash memory component is of the NAND flash type.

14. Device according to claim 4, wherein:
the master table block comprises a reserved memory space that corresponds to a backup-dedicated sector;
the corrupted sectors table comprises a reserved memory space that is less than or equal to approximately 1% of the memory space reserved for the master table block;
the wear levelling table comprises a reserved memory space of between about 20% and about 30% of the memory space reserved for the master table block; and
the logbook and message table comprises a reserved memory space of between about 30% and about 40% of the memory space reserved for the master table block.

15. Device according to claim 13, wherein:
the master table block comprises a reserved memory space that corresponds to a backup-dedicated sector;
the corrupted sectors table comprises a reserved memory space that is less than or equal to approximately 1% of the memory space reserved for the master table block;
the wear levelling table comprises a reserved memory space of between about 20% and about 30% of the memory space reserved for the master table block; and
the logbook and message table comprises a reserved memory space of between about 30% and about 40% of the memory space reserved for the master table block.

16. Method according to claim 9, wherein the management of said flash memory component is provided by a software program that is present on said microcontroller.

17. Method according to claim 10, wherein the management of said flash memory component is provided by a software program that is present on said microcontroller.
